(19) United States
(12) Patent Application Publication
(10) Pub. No.: US 2017/0343045 A1
(43) Pub. Date: Nov. 30, 2017

(54) ROLLING BEARING

(71) Applicant: MINEBEA MITSUMI INC., Nagano (JP)

(72) Inventors: Yusuke ASAI, Komoro (JP); Shintaro TAKATA, Komoro (JP); Akimi FURUKOSHI, Kitasaku (JP)

(73) Assignee: MINEBEA MITSUMI INC., Nagano (JP)

(21) Appl. No.: 15/603,012

(22) Filed: May 23, 2017

(30) Foreign Application Priority Data
May 27, 2016 (JP) 2016-106522

(51) Int. Cl. F16C 33/66; C10M 119/22; C10M 129/42; F16C 19/06; C10M 133/16; C10M 145/16; C10M 107/38; C10M 115/08; C10M 131/00

(52) U.S. Cl. CPC F16C 33/6633; C10M 115/08; C10M 119/22; C10M 129/42; C10M 131/00; C10M 133/16; C10M 145/16; C10M 107/38; F16C 19/06; C10M 2211/00; C10M 2209/086; C10M 2207/127; C10M 2203/024; C10M 2213/0606; C10M 2213/0626; C10M 2215/08; C10M 2215/1026; C10N 2230/04; C10N 2240/02; C10N 2250/10; F16C 2300/54; F16C 2240/06

(57) ABSTRACT

A rolling bearing is filled with a grease composition that contains a fluorine-based grease including a fluorine-based base oil and a fluorine-based thickener, a non-fluorine-based grease including a non-fluorine-based base oil and a non-fluorine-based thickener, and an additive serving as a dispersant. The non-fluorine-based thickener includes at least one of aliphatic-aromatic urea, alicyclic-aliphatic urea and aliphatic urea. The dispersant includes at least one of polycarboxylic acid metal salt, fluorine-containing group/lipophilic group-containing oligomer, fluorinated ether diamide, and organic acid metal salt.

### CROSS-REFERENCE TO RELATED APPLICATION(S)

The present application claims priority to and incorporates by reference the entire contents of Japanese Patent Application No. 2016-106522 filed in Japan on May 27, 2016.

### BACKGROUND OF THE INVENTION

### 1. Field of the Invention

The present invention relates to a rolling bearing.

### 2. Description of the Related Art

In recent years, the use environment required for rolling bearings has been increasingly severe, and there is a demand for excellent torque characteristic and longer life even in the operational environment exceeding 180° C.

In rolling bearings used under such a high-temperature condition, hybrid grease containing urea grease and fluorinated oil (PFPE) is often used. This is because urea grease alone does not endure an environment exceeding 180° C. but blending fluorinated oil having superior characteristics in high-temperature environments improves the heat resistance of grease (for example, see Japanese Patent Application Laid-open No. 2012-236935). Fluoropolymer particles are known as a thickener used in fluorinated oil. The fluoropolymer particles are a solid substance having an average particle diameter of a few hundreds of nanometers and, when filled in a rolling bearing, high torque is caused when the rolling elements go over the fluoropolymer particles. Fluorine is less reactive and chemically stable and therefore is less adsorptive on metal and has relatively poor lubricity. A technique for improving the lubricity is then used, in which urea grease is mixed to fluorinated oil to allow the urea thickener to flow into the oil film surface (see Japanese Patent Application Laid-open No. 2011-084646). According to the technique described above, the torque caused by the fluoropolymer is reduced due to the effect of the urea thickener included in the urea grease. This phenomenon is particularly significant during initial rotation of the rolling bearing and affects low-speed torque.

In the hybrid grease, fluorinated oil and urea grease are not dissolved but are present in a dispersed state. Therefore, when the dispersiveness of the hybrid grease decreases, the fluoropolymer particles serving as a thickener for the fluorinated oil or the aggregates thereof enter between the rolling element and the inner ring or the outer ring to produce resistance against the rotation of the rolling bearing, leading to an increase in low-speed torque of the rolling bearing.

### SUMMARY OF THE INVENTION

The present invention is made in view of the foregoing and is aimed to provide a rolling bearing using a grease composition in which favorable low-speed torque is kept and favorable lubrication characteristics are kept in long-term use in a high-temperature environment.

A rolling bearing filled with a grease composition according to an embodiment includes a fluorine-based grease including a fluorine-based base oil and a fluorine-based thickener; a non-fluorine-based grease including a non-fluorine-based base oil and a non-fluorine-based thickener; and an additive serving as a dispersant, wherein the non-fluorine-based thickener includes at least one of an aliphatic-aromatic urea, an alicyclic-aliphatic urea, and an aliphatic urea, and the dispersant includes at least one of a polycarboxylic acid metal salt, a fluorine-containing group/lipophilic group-containing oligomer, a fluorinated ether diamide, and an organic acid metal salt.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a cross-sectional view of a rolling bearing according to the present embodiment; and

FIG. 2 is a graph illustrating the relation between the diameter of a rolling element and the torque ratio.

### DETAILED DESCRIPTION OF THE PREFERRED EMBODIMENTS

A rolling bearing according to an embodiment of the present invention and a grease composition filled in the rolling bearing will be described in details below with reference to the accompanying drawings. It should be noted that the following embodiment is not intended to limit the present invention.

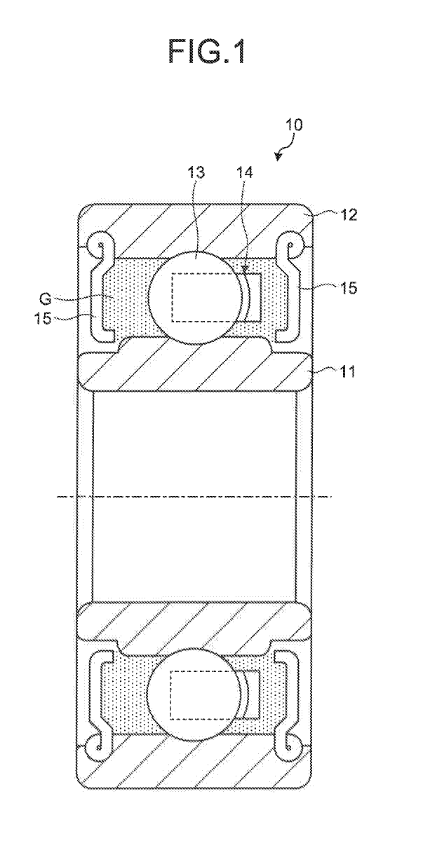

FIG. 1 is a cross-sectional view of a rolling bearing 10 according to the present embodiment. The rolling bearing 10 includes an inner ring 11, an outer ring 12, a plurality of rolling elements 13, a retainer 14, and a seal member 15. The inner ring 11 is a cylindrical structure installed on the outside of a not-illustrated shaft. The outer ring 12 is a cylindrical structure disposed concentrically with the inner ring 11 on the outer peripheral side of the inner ring 11. A plurality of rolling elements 13 are balls disposed in the raceway formed between the inner ring 11 and the outer ring 12. The rolling bearing 10 is thus a ball bearing. The retainer 14 is disposed in the raceway to hold a plurality of rolling elements 13. The seal member 15 protrudes from the inner peripheral surface of the outer ring 12 toward the inner ring 11 and seals the interior space of the bearing. Grease composition G is filled in the interior enclosed by the seal member 15. In the rolling bearing 10 having a configuration described above, the grease composition G acts to reduce friction between the rolling elements 13 and the retainer 14, and also friction between the rolling elements 13 and the inner ring 11 or the outer ring 12. As can be understood from the configuration illustrated in FIG. 1, the grease composition G filled in the rolling bearing 10 enters between the rolling element 13 and the inner ring 11 and the outer ring 12 when the rolling bearing 10 rotates.

The inventors of the present invention have conducted detailed studies about the use of hybrid grease as the grease composition G and found that when the grease composition G is filled in the rolling bearing 10 and used for a long time in a high-temperature environment (for example 180° C. or higher), the urea thickener hardens and aggregates due to thermal degradation, and low-speed torque of the rolling bearing increases due to decrease of the dispersiveness in the grease composition.

In hybrid grease, fluorinated oil and urea grease are not dissolved but are present in a dispersed state. Accordingly, when the dispersiveness of the hybrid grease is reduced, the fluoropolymer particles serving as a thickener for the fluorinated oil or the aggregates thereof enter between the rolling element 13 and the inner ring 11 or the outer ring 12 producing resistance against the rotation of the rolling bearing 10. This is thought to lead to increase of low-speed torque of the rolling bearing 10.

The grease composition filled in the rolling bearing according to the present embodiment then contains a specific dispersant as described below and is further combined with a specific thickener as described below. The specific dispersant and thickener will be described below.

The grease composition filled in the rolling bearing according to the present embodiment is so-called hybrid grease including a fluorine-based grease and a non-fluorine-based grease in combination. The grease composition contains a base oil and a thickener corresponding to the fluorine-based grease (hereinafter referred to as fluorine-based base oil and fluorine-based thickener), a base oil and a thickener corresponding to the non-fluorine-based grease (hereinafter to as non-fluorine-based base oil and non-fluorine-based thickener), and further an additive working as a dispersant.

The content rate of the non-fluorine-based grease based on the entire hybrid grease is preferably in the range between 10 wt % and 50 wt % inclusive, in particular preferably in the range between 10 wt % and 30 wt % inclusive. As the content rate of the non-fluorine-based grease in relation to the entire hybrid grease increases, the content rate of the fluorine-based grease (thus, the content rate of the fluoropolymer particles) reduces. This reduction leads to suppressing the torque caused when the rolling elements go over the fluoropolymer particles (the thickener for the fluorinated oil). Accordingly, it can be said that, from the point of view of torque reduction, the content rate of the non-fluorine-based grease in the range of 10 wt % to 30 wt % inclusive is preferable to be as higher as possible.

The fluorine-based base oil is mainly composed of, for example, perfluoropolyether (PFPE). PFPE is represented by a general formula: RfO(CF₂O)ₚ(C₂F₄O)_{q}(C₃F₆O)ᵣRf where Rf is perfluoro lower alkyl group, and p, q, r are integers.

For example, as the fluorine-based thickener, it is preferable to use particles of polytetrafluoroethylene (PTFE). PTFE is a polymer of tetrafluoroethylene and is represented by general formula [C₂F₄]ₙ where n is degree of polymerization. Examples of other fluorine-based thickeners that may be employed include perfluoroethylene-propylene copolymer (FEP), ethylene-tetrafluoroethylene copolymer (ETFE) and tetrafluoroethylene-perfluoroalkyl vinyl ether copolymer (PFA).

The non-fluorine-based base oil is not limited to a particular type. Oils commonly used as grease base oil such as synthetic hydrocarbon oil, alkyl ether oil, alkyl diphenyl ether oil, ester oil, mineral oil, fluorinated oil and silicone oil can be used singly or in combination.

Examples of the synthetic hydrocarbon oil include poly-α-olefins such as normal paraffin, isoparaffin, polybutene, polyisobutylene, 1-decene oligomer, and 1-decene ethylene oligomer. Examples of the ester oil include: diester oils such as dibutyl sebacate, di-2-ethylhexyl sebacate, dioctyl sebacate, dioctyl adipate, diisodecyl adipate, ditridecyl adipate, ditridecyl tallate, and methyl/acetyl cinoleate; aromatic ester oils such as trioctyl trimellitate, tri-2-ethylhexyl trimellitate, tridecyl trimellitate, tetraoctyl pyromellitate and tetra-2-ethylhexyl pyromellitate; polyol ester oils such as trimethylolpropane caprylate, trimethylolpropane pelargonate, pentaerythritol-2-ethyl hexanoate and pentaerythritol pelargonate; and carbonic acid ester oils. Examples of the alkyl diphenyl ether oil include monoalkyl diphenyl ether, dialkyl diphenyl ether and polyalkyl diphenyl ether. Among those described above, the aromatic ester oils are preferred and can be used singly or in combination. In particular, it is preferable to use base oil including tri-2-ethylhexyl trimellitate and tetra-2-ethylhexyl pyromellitate in combination.

As the non-fluorine-based thickener, it is preferable to use for example a urea compound. A urea compound such as a diurea compound, a triurea compound, and a polyurea compound can be used as the urea compound. In particular, it is preferable to use a diurea compound in terms of heat resistance and acoustic characteristic (low-noise characteristic). Aliphatic-aromatic urea, alicyclic-aliphatic urea and aliphatic urea are preferable as the urea compound.

More specifically, the non-fluorine-based thickener suitable for the present embodiment is a diurea compound that can be represented by following general formula (1):

R₁—NHCONH—R₂—NHCONH—R₃ (1)

where R₁ and R₃ may be an aliphatic hydrocarbon group, an alicyclic hydrocarbon group or an aromatic hydrocarbon group, where at least one of R₁ and R₃ is an aliphatic hydrocarbon group or an alicyclic hydrocarbon group. R₂ is an aromatic hydrocarbon group.

As starting materials used in the synthesis of the above diurea compound, an amine compound and an isocyanate compound are used. As the amine compound, aliphatic amines such as hexylamine, octylamine, dodecylamine, hexadecylamine, octadecylamine, stearylamine, and oleylamine; and alicyclic amines such as hexylamine; as well as aromatic amines such as aniline, p-toluidine, and ethoxyphenylamine are used. As the isocyanate compound, phenylene diisocyanate, tolylene diisocyanate, diphenyl diisocyanate, diphenylmethane diisocyanate, octadecane diisocyanate, decane diisocyanate, and hexane diisocyanate are used. It is preferable to use an aliphatic aromatic diurea compound synthesized using the aliphatic amine and the aromatic amine as amine starting materials with the aromatic isocyanate.

For example, an organic acid metal salt is preferable as the additive added as a dispersant, and in particular, a sodium salt of polycarboxylic acid is preferable. An aliphatic carboxylic acid is preferable as carboxylic acid included in the polycarboxylic acid, and either an aliphatic saturated carboxylic acid or an aliphatic unsaturated carboxylic acid may be used. Examples of the unsaturated carboxylic acid include acrylic acid, crotonic acid, isocrotonic acid, 3-butenoic acid, methacrylic acid, angelic acid, tiglic acid, 4-pentenoic acid, 2-ethyl-2-butenoic acid, 10-undecenoic acid, and oleic acid. Examples of the saturated dicarboxylic acid include oxalic acid, malonic acid, succinic acid, glutaric acid, adipic acid, pimelic acid, suberic acid, azelaic acid, and sebacic acid. Examples of the saturated carboxylic acid include formic acid, acetic acid, propionic acid, butyric acid, valeric acid, caproic acid, enanthic acid, caprylic acid, pelargonic acid, capric acid, lauric acid, myristic acid, palmitic acid, margaric acid, and stearic acid. Examples of the unsaturated dicarboxylic acid include fumaric acid, maleic acid, and itaconic acid. The polycarboxylic acid formed with those carboxylic acids may be a polymer of monocarboxylic acid or a polymer of dicarboxylic acid.

Polymers of unsaturated carboxylic acids including one or two carboxyl groups are particularly preferable. The metal salts of these carboxylic acids may form a copolymer with a hydrocarbon compound. That is, the grease composition may include a copolymer of metal salt of carboxylic acid as a dispersant. The grease composition may include at least one of a metal salt of a polycarboxylic acid or a copolymer of a carboxylic acid metal salt and a hydrocarbon compound. Specific examples of the metal salt of a polycarboxylic acid or the carboxylic acid metal salt that forms the copolymer of a carboxylic acid metal salt and a hydrocarbon compound include at least one selected from alkali metal salts and alkaline-earth metal salts. Lithium salt, potassium salt, and the like are preferable as an alkali metal salt in addition to sodium salt in the grease composition G, and magnesium salt, calcium salt, and the like are preferable as the alkaline-earth metal salt. Examples of the hydrocarbon compound polymerized (polymerization reaction) with a carboxylic acid metal salt in the copolymer of a carboxylic acid metal salt and a hydrocarbon compound include isobutylene, propylene, isoprene, and butadiene. Specific examples of the compound include a polyacrylic acid sodium salt and a copolymer of maleic acid sodium salt and isobutylene.

The weight-average molecular weight of the polycarboxylic acid is preferably a weight-average molecular weight (Mw) of 5000 or more and 200000 or less in terms of polyethylene glycol by gel permeation chromatography (GPC), more preferably 7000 or more and 80000 or less, further preferably 9000 or more and 16000 or less.

Examples of other additives added as a dispersant include fluorine-containing group/lipophilic group-containing oligomers, fluorinated ether diamides, and organic acid metal salts. Dispersiveness can be expected with any salts of aromatic organic acids, aliphatic organic acids, and alicyclic organic acids as the organic acid of the organic acid metal salt. Monobasic acids or polybasic organic acids can be used as the organic acid. Specific examples of the organic acid include: monovalent saturated fatty acids such as formic acid, acetic acid, propionic acid, butyric acid, valeric acid, caproic acid, heptanoic acid, caprylic acid, pelargonic acid, capric acid, undecylic acid, lauric acid, tridecylic acid, myristic acid, pentadecylic acid, palmitic acid, margaric acid, stearic acid, nonadecylic acid, and arachic acid; monovalent unsaturated fatty acids such as acrylic acid, crotonic acid, undecylenic acid, oleic acid, and gadoleic acid; divalent saturated fatty acids such as malonic acid, methylmalonic acid, succinic acid, methylsuccinic acid, dimethylmalonic acid, ethylmalonic acid, glutaric acid, adipic acid, dimethylsuccinic acid, pimelic acid, tetramethylsuccinic acid, suberic acid, azelaic acid, sebacic acid, and brassylic acid; divalent unsaturated fatty acids such as fumaric acid, maleic acid, and oleic acid; fatty acid derivatives such as tartaric acid and citric acid; and aromatic organic acids such as benzoic acid, phthalic acid, trimellitic acid, and pyromellitic acid. The organic acid is preferably metal salt thereof, and among metal salts, sodium salt is preferable. Preferable examples of the metal salt of an organic acid include sodium benzoate, sebacic acid monosodium salt, sebacic acid disodium salt, succinic acid monosodium salt, and succinic acid disodium salt. Examples of the fluorine-containing group in the fluorine-containing group/lipophilic group-containing oligomer include perfluoroalkyl group and perfluoroalkenyl group. Examples of the lipophilic group include one or two or more of alkyl groups, phenyl groups, siloxane groups, and the like. Examples of the hydrophilic group include one or two or more of ethylene oxides, amide groups, ketone groups, carboxyl groups, and sulfone groups.

In the grease composition G, the amount of the additive added as a dispersant is preferably 0.5 wt % or more.

The grease composition may further contain, as other additives, extreme pressure additive, antioxidant, anti-friction agent, metal deactivator, rust preventive, oiliness agent, viscosity index improver, and the like, if necessary.

The grease composition filled in the rolling bearing according to the present embodiment having a configuration as described above is a hybrid grease including a fluorine-based grease and a non-fluorine-based grease in combination that contains a specific dispersant described above, and by combining with a specific non-fluorine-based thickener described above (at least one of aliphatic-aromatic urea, alicyclic-aliphatic urea, and aliphatic urea) the improvement of dispersiveness of the fluorine-based thickener in the hybrid grease is achieved. As a result, in the rolling bearing filled with the grease composition, favorable low-speed torque is kept, and favorable lubrication characteristics (high-temperature durability) are kept even in long-term use in a high-temperature environment.

Verification Test

The results of verification test will be described below. The test is to verify that the rolling bearing according to the present embodiment filled with the grease composition described above keeps favorable low-speed torque and favorable lubrication characteristic (high-temperature durability) even when used for long period in a high-temperature environment.

Specifically, a variety of grease compositions were prepared, and the characteristics of rolling bearings were compared and analyzed in terms of the difference in additives (Comparative Analysis 1), the difference in non-fluorine-based thickeners (Comparative Analysis 2), and the difference in content rate between fluorine-based grease and non-fluorine grease (Comparative Analysis 3). In all of the comparative analyses, (1) low-speed torque and (2) high-temperature durability were considered as evaluation items.

The evaluation item (1) low-speed torque is the maximum value of torque measured during one minute of initial rotation when a rolling bearing with a preload of 39 N is rotated at a rotational speed of 0.1 rpm. The rolling bearing with the measured low-speed torque value corresponding to 10 mN·m or lower is considered as a non-defective product. As for the evaluation item (2) high-temperature durability, a rolling bearing with a preload of 39 N is rotated in a temperature environment of 180° C. at a rotational speed of 3000 rpm during 15000 hours. After this rotation in high temperature, the rolling bearing is rotated at room temperature at a rotational speed of 30 rpm during one minute and the torque is measured at the same time. The rolling bearing with the measured value corresponding to 5 mN·m or less is considered as a non-defective product.

Comparative Analysis 1

In Comparative Analysis 1, rolling bearings according to the present embodiment filled with a grease composition including a dispersant (Group A) are compared with rolling bearings filled with a grease not including an additive or a grease composition including an additive different from those in Group A (Group B). Table 1 provides a summary of the results of Comparative Analysis 1.

TABLE 1

| | | | | Group A | | | | Group B | | | | |
|---|---|---|---|---|---|---|---|---|---|---|---|---|
| | | | | Example | Example | Example | Example | Comparative | Comparative | Comparative | Comparative | Comparative |
| Grease | Composition | Starting material | Component | 1 | 2 | 3 | 4 | Example 1 | Example 2 | Example 3 | Example 4 | Example 5 |
| Fluorinated | Thickener | Fluoropolymer | PTFE | ◯ | ◯ | ◯ | ◯ | ◯ | ◯ | ◯ | ◯ | ◯ |
| grease | Base oil | Fluorinated oil | PFPE | ◯ | ◯ | ◯ | ◯ | ◯ | ◯ | ◯ | ◯ | ◯ |
| Non- | Thickener | Urea thickener | Aliphatic-aromatic urea | ◯ | ◯ | ◯ | ◯ | ◯ | | | ◯ | |
| fluorinated | | | Alicyclic-aliphatic urea | | | | | | ◯ | | | ◯ |
| grease | | | Aliphatic urea | | | | | | | ◯ | | |
| | | | Aromatic urea | | | | | | | | | |
| | | Metal soap | 12OHLi soap | | | | | | | | | |
| | | thickener | Ba complex soap | | | | | | | | | |
| | | | Na complex soap | | | | | | | | | |
| | | | Ca soap | | | | | | | | | |
| | Base oil | Synthetic oil | Synthetic oil | ◯ | ◯ | ◯ | ◯ | ◯ | ◯ | ◯ | ◯ | ◯ |
| | Content rate (based an entire grease) | | | 10 wt % | 10 wt % | 10 wt % | 10 wt % | 10 wt % | 10 wt % | 10 wt % | 10 wt % | 10 wt % |
| Additive | | | Copolymer of maleic acid | 1% | | | | | | | | |
| | | | sodium self and | | | | | | | | | |
| | | | isobutylene | | | | | | | | | |
| | | | Fluorine-containing | | 1% | | | | | | | |
| | | | group/lipophilic group- | | | | | | | | | |
| | | | containing oligomer | | | | | | | | | |
| | | | Fluorinated ether diamide | | | 1% | | | | | | |
| | | | Sebacic acid disodium salt | | | | 1% | | | | | |
| | | | Carboxylic acid ammonium | | | | | | | | 1% | |
| | | | salt | | | | | | | | | |
| | | | Fluroine-containing | | | | | | | | | 1% |
| | | | group/hydrophilic group- | | | | | | | | | |
| | | | containing oligomer | | | | | | | | | |

| Evaluation result | (1) Low-speed torque | Measured value | 6.5 | 5.2 | 5.2 | 5.2 | 6 | 1.8 | 6 | 6 | 1.9 |
|---|---|---|---|---|---|---|---|---|---|---|---|
| | | Determination (10 mN · m | OK | OK | OK | OK | OK | OK | OK | OK | OK |
| | | or lower: OK, exceeding | | | | | | | | | |
| | | 10 mN · m: NG) | | | | | | | | | |
| | (2) High-temperature | Measured value | 2.2 | 2.4 | 2.5 | 2.2 | 5.2 | 5.5 | 6.5 | 5.5 | 6.4 |
| | durability | Determination (5 mN · m | OK | OK | OK | OK | NG | NG | NG | NG | NG |
| | Low-speed torque after | or lower: OK, exceeding | | | | | | | | | |
| | bearing lifetime test | 5 mN · m: NG) | | | | | | | | | |

As illustrated in Table 1, Example 1 to Example 4 belonging to Group A are rolling bearings filled with a grease composition that contains a grease including a fluorine-based base oil and a fluorine-based thickener, and a grease including a non-fluorine-based base oil and a non-fluorine-based thickener, and contains as dispersant a copolymer of maleic acid sodium salt and isobutylene, a fluorine-containing group/lipophilic group-containing oligomer, a fluorinated ether diamide or sebacic acid disodium salt. In Comparative Analysis 1, the copolymer of maleic acid sodium salt and isobutylene is used as an example of the polycarboxylic acid metal salt, and sebacic acid disodium salt is used as an example of the organic acid metal salt.

As illustrated in Table 1, in order to ensure the accuracy of evaluation in the verification test, the components of the fluorine-based base oil, the fluorine-based thickener, the non-fluorine-based base oil, and the non-fluorine-based thickener are the same in the grease compositions used in Group A, and the content rate of the non-fluorine-based grease based on the entire grease composition is also the same.

On the other hand, Comparative Example 1 to Comparative Example 3 belonging to Group B are rolling bearings filled with a grease composition that contains a fluorine-based base oil and a fluorine-based thickener, and a non-fluorine-based base oil and a non-fluorine-based thickener, but does not include any additive. Comparative Example 4 and Comparative Example 5 belonging to Group B are rolling bearings filled with a grease composition that includes an additive, but the additive is not the same additive as described above, that is, the additive is not a copolymer of maleic acid sodium salt and isobutylene, a fluorine-containing group/lipophilic group-containing oligomer, a fluorinated ether diamide or sebacic acid disodium salt.

As can be understood from the comparison between Group A and Group B, the rolling bearings filled with a grease composition of Group A are evaluated as non-defective products in both of the evaluation items (1) low-speed torque and (2) high-temperature durability, whereas the rolling bearings filled with a grease composition in Group B are not evaluated as non-defective products in the evaluation item (2) high-temperature durability.

Comparative Analysis 1 thus demonstrated that the rolling bearing filled with a grease composition of Group A corresponding to the grease composition containing a fluorine-based grease and a non-fluorine-based grease added with a copolymer of maleic acid sodium salt and isobutylene, a fluorine-containing group/lipophilic group-containing oligomer, a fluorinated ether diamide or sebacic acid disodium salt, maintains favorable low-speed torque in the evaluation of item (1) low-speed torque and excellent lubricity (high-temperature durability) in the evaluation of item (2) long-term use in a high-temperature environment, when compared with the rolling bearing filled with a grease composition of Group B.

Comparative Analysis 2

In Comparative Analysis 2, rolling bearings of Group C filled with a grease composition including the non-fluorine-based thickener described previously (at least one of aliphatic-aromatic urea, alicyclic-aliphatic urea, and aliphatic urea) are compared with rolling bearings of Group D filled with a grease composition including a non-fluorine-based thickener different from the non-fluorine-based thickener described previously. Table 2 provides a summary of the results of Comparative Analysis 2. Also in Comparative Analysis 2, similar to Comparative Analysis 1, a copolymer of maleic acid sodium salt and isobutylene is used as an example of the polycarboxylic acid metal salt, and sebacic acid disodium salt is used as an example of the organic acid metal salt.

TABLE 2

| | | | | Group C | | | Group D | | | | | |
|---|---|---|---|---|---|---|---|---|---|---|---|---|
| | | | | Example | Example | Example | Comparative | Comparative | Comparative | Comparative | Comparative | Comparative |
| Grease | Composition | Starting material | Component | 1 | 5 | 6 | Example 6 | Example 7 | Example 8 | Example 9 | Example 10 | Exemple 11 |
| Fluorinated | Thickener | Fluoropolymer | PTFE | ◯ | ◯ | ◯ | ◯ | ◯ | ◯ | ◯ | ◯ | ◯ |
| grease | Base oil | Fluorinated oil | PFPE | ◯ | ◯ | ◯ | ◯ | ◯ | ◯ | ◯ | ◯ | ◯ |
| Non- | Thickener | Urea thickener | Aliphatic-aromatic urea | ◯ | | | | | | | | |
| fluorinated | | | Alicyclic-aliphatic urea | | ◯ | | | | | | | |
| grease | | | Aliphatic urea | | | ◯ | | | | | | |
| | | | Aromatic urea | | | | ◯ | ◯ | | | | |
| | | Metal soap | 12OHLi soap | | | | | | ◯ | | | |
| | | thickener | Ba complex soap | | | | | | | ◯ | | |
| | | | Na complex soap | | | | | | | | ◯ | |
| | | | Ca soap | | | | | | | | | ◯ |
| | Base oil | Synthetic oil | Synthetic oil | ◯ | ◯ | ◯ | ◯ | ◯ | ◯ | ◯ | ◯ | ◯ |

| | | | | | | | | | |
|---|---|---|---|---|---|---|---|---|---|
| Content rate (based an entire grease) | 10 wt % | 10 wt % | 10 wt % | 10 wt % | 30 wt % | 30 wt % | 30 wt % | 30 wt % | 30 wt % |

| Additive | Copolymer of maleic acid | 1% | 1% | 1% | 1% | 1% | 1% | 1% | 1% | 1% |
|---|---|---|---|---|---|---|---|---|---|---|
| | sodium self and | | | | | | | | | |
| | isobutylene | | | | | | | | | |
| | Fluorine-containing | | | | | | | | | |
| | group/lipophilic group- | | | | | | | | | |
| | containing oligomer | | | | | | | | | |
| | Fluorinated ether diamide | | | | | | | | | |
| | Sebacic acid disodium salt | | | | | | | | | |
| | Carboxylic acid ammonium | | | | | | | | | |
| | salt | | | | | | | | | |
| | Fluroine-containing | | | | | | | | | |
| | group/hydrophilic group- | | | | | | | | | |
| | containing oligomer | | | | | | | | | |

| | | | | | | | | | | | |
|---|---|---|---|---|---|---|---|---|---|---|---|
| Evaluation result | (1) Low-speed torque | Measured value | 6.5 | 6 | 1.9 | 17 | 14 | 15 | 14 | 13 | 14 |
| | | Determination (10 mN · m | OK | OK | OK | NG | NG | NG | NG | NG | NG |
| | | or lower: OK, exceeding | | | | | | | | | |
| | | 10 mN · m: NG) | | | | | | | | | |
| | (2) High-temperature | Measured value | 2.2 | 2.8 | 4 | 4 | 4.6 | 12 | 10 | 10 | 14 |
| | durability | Determination (5 mN · m | OK | OK | OK | OK | OK | NG | NG | NG | NG |
| | Low-speed torque after | or lower: OK, exceeding | | | | | | | | | |
| | bearing lifetime test | 5 mN · m: NG) | | | | | | | | | |

As illustrated in Table 2, Example 1, Example 5 and Example 6 belonging to Group C are rolling bearings filled with a grease composition that contains a fluorine-based base oil and a fluorine-based thickener, a non-fluorine-based base oil and a non-fluorine-based thickener, and an additive serving as a dispersant. The non-fluorine-based thickener is aliphatic-aromatic urea, alicyclic-aliphatic urea or aliphatic urea. As illustrated in Table 2, for the accuracy of evaluation, the components and the amount of the additive are the same in the grease compositions used in Group C.

Comparative Example 6 to Comparative Example 11 belonging to Group D are rolling bearings filled with a grease composition that contains a non-fluorine-based thickener different from aliphatic-aromatic urea, alicyclic-aliphatic urea and aliphatic urea, i.e., aromatic urea or metal soap-based thickener. In Comparative Example 6 belonging to Group D, the content rate of the non-fluorine grease based on the entire grease composition is the same (10 wt %) as in Example 1, Example 5, and Example 6 belonging to Group C. On the other hand, in Comparative Example 7 to Comparative Example 11 belonging to Group D, the content rate of the non-fluorine-based grease is set to be higher than that of Example 1, Example 5, and Example 6. Specifically, in Example 1, Example 5 and Example 6 belonging to Group C, the content rate of the non-fluorine grease is 10 wt %, whereas in Comparative Example 7 to Comparative Example 11 belonging to Group D, the content rate of the non-fluorine grease is 30 wt %. The components and the amount of the dispersant in Comparative Example 6 to Comparative Example 11 are set to be the same (1%) as in Example 1, Example 5 and Example 6.

As can be understood from the comparison between Group C and Group D, the rolling bearings belonging to Group C are evaluated as non-defective products with respect to both of the evaluation items (1) low-speed torque and (2) high-temperature durability, whereas the rolling bearings belonging to Group D are not evaluated as non-defective products with respect to the evaluation item (1) low-speed torque.

According to the above evaluation results, Comparative Analysis 2 has confirmed that, when using the grease composition containing a fluorine-based grease and a non-fluorine-based grease, the rolling bearings filled with a grease composition belonging to Group C containing aliphatic-aromatic urea, alicyclic-aliphatic urea or aliphatic urea as the non-fluorine-based thickener maintain more favorable low-speed torque in evaluation item (1) low-speed torque, compared to the rolling bearings filled with a grease composition containing aromatic urea as in Comparative Example 6 and Comparative Example 7 of Group D.

It has also been verified that the rolling bearings belonging to Group C keep favorable low-speed torque in evaluation item (1) low-speed torque and excellent lubricity (high-temperature durability) in evaluation item (2) long-term use in a high-temperature environment, compared to the rolling bearings in Comparative Example 8 to Comparative Example 11 containing a metal soap thickener as the non-fluorine-based thickener.

As previously mentioned, the content rate of the non-fluorine-based grease based on the entire grease composition is preferable to be as higher as possible in the range of 10 wt % to 30 wt % inclusive. However, the evaluation results described above have confirmed that although the content rate of the non-fluorine-based grease in Group C (10 wt %) is lower than in Comparative Example 7 to Comparative Example 11 (30 wt %), Group C is superior to Group D in relation to both (1) low-speed torque and (2) high-temperature durability. As can be understood from the foregoing explanation, the grease composition belonging to Group C containing aliphatic-aromatic urea, alicyclic-aliphatic urea or aliphatic urea as the non-fluorine-based thickener achieves the both effects of keeping favorable low-speed torque and keeping excellent lubricity (high-temperature durability) in long-term use in a high-temperature environment.

Comparative Analysis 3

In Comparative Analysis 3, rolling bearings filled with a grease composition in which the content rate of the non-fluorine-based grease based on the entire grease composition is in the range of 10 wt % to 50 wt % inclusive (Group E) are compared with rolling bearings filled with a grease composition with the content rate falling outside this range (Group F). Table 3 provides a summary of the results of Comparative Analysis 3. Also in Comparative Analysis 3, similar to Comparative Analysis 1 and Comparative Analysis 2, a copolymer of maleic acid sodium salt and isobutylene is used as an example of the polycarboxylic acid metal salt, and sebacic acid disodium salt is used as an example of the organic acid metal salt.

TABLE 3

| | | | | | | | Group F | |
|---|---|---|---|---|---|---|---|---|
| | | | | Group E | | | Comparative | Comparative |
| Grease | Composition | Starting material | Component | Example 1 | Example 7 | Example 8 | Example 12 | Example 13 |
| Flourinated | Thickener | Fluoropolymer | PTFE | ◯ | ◯ | ◯ | ◯ | ◯ |
| grease | Base oil | Fluorinated oil | PFPE | ◯ | ◯ | ◯ | ◯ | ◯ |
| Non- | Thickener | Urea thickener | Aliphatic-aromatic urea | ◯ | ◯ | ◯ | ◯ | ◯ |
| fluorinated | | | Alicyclic-aliphatic urea | | | | | |
| grease | | | Aliphatic urea | | | | | |
| | | | Aromatic urea | | | | | |
| | | Metal soap | 12OHLi soap | | | | | |
| | | thickener | Ba complex soap | | | | | |
| | | | Na complex soap | | | | | |
| | | | Ca soap | | | | | |
| | Base oil | Synthetic oil | Synthetic oil | ◯ | ◯ | ◯ | ◯ | ◯ |

| | | | | | |
|---|---|---|---|---|---|
| Content rate (based an entire grease) | 10 wt % | 30 wt % | 50 wt % | 5 wt % | 50 wt % |

| Additive | | Copolymer of maleic acid | 1% | 1% | 1% | 1% | 1% |
|---|---|---|---|---|---|---|---|
| | | sodium self and | | | | | |
| | | isobutylene | | | | | |
| | | Fluorine-containing | | | | | |
| | | group/lipophilic group- | | | | | |
| | | containing oligomer | | | | | |
| | | Fluorinated ether diamide | | | | | |
| | | Sebacic acid disodium salt | | | | | |
| | | Carboxylic acid ammonium | | | | | |
| | | salt | | | | | |
| | | Fluroine-containing | | | | | |
| | | group/hydrophilic group- | | | | | |
| | | containing oligomer | | | | | |
| Evaluation result | (1) Low-speed torque | Measured value | 6.5 | 5.2 | 5.2 | 12 | 3 |
| | | Determination (10 mN · m | OK | OK | OK | NG | OK |
| | | or lower: OK, exceeding | | | | | |
| | | 10 mN · m: NG) | | | | | |
| | (2) High-temperature | Measured value | 2.2 | 3.6 | 4.5 | 4.8 | 10 |
| | durability | Determination (5 mN · m | OK | OK | OK | OK | NG |
| | Low-speed torque after | or lower: OK, exceeding | | | | | |
| | bearing lifetime test | 5 mN · m: NG) | | | | | |

In Table 3, Example 1, Example 7 and Example 8 belonging to Group E are rolling bearings filled with a grease composition in which the content rate of the non-fluorine-based grease based on the entire grease composition is in the range between 10 wt % and 50 wt % inclusive. For the accuracy of evaluation, the components of the fluorine-based base oil, the fluorine-based thickener, the non-fluorine-based base oil, the non-fluorine-based thickener and the additive are the same in the grease compositions of Group E.

On the other hand, Comparative Example 12 and Comparative Example 13 belonging to Group F are rolling bearings filled with grease compositions having the content rate of the non-fluorine-based grease based on the entire grease composition of 5 wt % and 60 wt % respectively. Similarly, for the accuracy of evaluation, the components of the fluorine-based base oil, the fluorine-based thickener, the non-fluorine-based base oil, the non-fluorine-based thickener and the additive are the same in the grease compositions of Group F.

Comparison between Group E and Group F shows that the rolling bearings belonging to Group E are evaluated as non-defective products in both of the evaluation items (1) low-speed torque and (2) high-temperature durability, whereas the rolling bearing in Comparative Example 11 belonging to Group F is not evaluated as a non-defective product with respect to the evaluation item (1) low-speed torque, and the rolling bearing in Comparative Example 12 belonging to Group F is not evaluated as a non-defective product with respect to the evaluation item (2) high-temperature durability.

According to the above evaluation results, Comparative Analysis 3 has demonstrated that, with respect to the grease composition containing a fluorine-based grease and a non-fluorine-based grease, in Group E in which the content rate of the non-fluorine-based grease based on the entire grease composition in the grease composition containing a fluorine-based grease and a non-fluorine-based grease is in the range of 10 wt % to 50 wt % inclusive, favorable low-speed torque is kept and excellent lubricity is kept in long-term use in a high-temperature environment (high-temperature durability), compared with Comparative Example 11 in which the content rate of the non-fluorine grease is less than 10 wt % or Comparative Example 12 in which the content rate exceeds 50 wt %.

Comparative Analysis 4

In Comparative Analysis 4 which focuses on the relation between the diameter of the rolling element of a rolling bearing and torque, the effect of the change in the diameter of the rolling element on the torque ratio is examined. Here, the “torque ratio” means the ratio between the measured value of low-speed torque of the rolling bearing according to a comparative example and the measured value of low-speed torque of the rolling bearing according to an embodiment. More specifically, torque ratio=(measured value of low-speed torque of the rolling bearing according to a comparative example)/(measured value of low-speed torque of the rolling bearing according to an embodiment). Table 4 illustrates the inner diameter size, the outer diameter size, the diameter of the rolling element, and the torque ratio for each of four different rolling bearings (Type A to Type D).

TABLE 4
Torque ratio list

| | Inner diameter | Outer diameter | Diameter of rolling | Torque |
|---|---|---|---|---|
| | size (mm) | size (mm) | element (mm) | ratio |
| Type A | 15 | 35 | 6.35 | 1.00 |
| Type B | 10 | 26 | 4.76 | 1.13 |
| Type C | 8 | 22 | 3.97 | 2.57 |
| Type D | 6 | 12 | 1.59 | 3.50 |

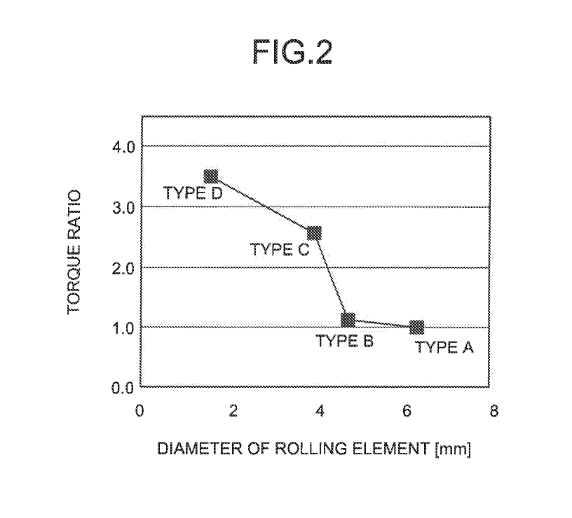

The inner diameter sizes of the rolling bearings (Type A to Type D) are 15 mm (Type A), 10 mm (Type B), 8 mm (Type C), and 6 mm (Type D), and the outer diameter sizes of the rolling bearings (Type A to Type D) are 35 mm (Type A), 26 mm (Type B), 22 mm (Type C), and 12 mm (Type D). The diameter of the rolling element is the diameter of the balls disposed in the raceway formed between the inner ring and the outer ring in the rolling bearing. The torque ratio is obtained using the rolling bearing in Example 2 as the rolling bearing according to the embodiment and the rolling bearing in Comparative Example 8 as the rolling bearing according to the comparative example. More specifically, torque ratio=(measured value of low-speed torque of the rolling bearing filled with the grease composition of Comparative Example 8)/(measured value of low-speed torque of the rolling bearing filled with the grease composition of Example 2). FIG. 2 is a graph showing the torque ratios listed in Table 4.

As can be understood from Table 4 and FIG. 2, the diameters of the rolling elements of the rolling bearings (Type A to Type D) are 6.35 mm (Type A), 4.76 mm (Type B), 3.97 mm (Type C), and 1.59 mm (Type D), and the torque ratios of the rolling bearings are 1.00 (Type A), 1.13 (Type B), 2.57 (Type C), and 3.50 (Type D). The torque ratio is higher in the rolling bearings with a rolling element diameter of 5 mm or smaller (Type B, Type C, Type D), compared with the rolling bearing with a rolling element diameter exceeding 5 mm (Type A). Note that the higher torque ratio, the more favorable the low-speed torque of the embodiment is. In other words, more favorable low-speed torque is obtained when the grease composition filled in the rolling bearing according to the embodiment is used in a rolling bearing having a rolling element diameter of 5 mm or smaller, compared with when used in a rolling bearing having a rolling element diameter exceeding 5 mm.

Furthermore, focusing on the rolling bearings Type C and Type D with a rolling element diameter of 4 mm or smaller, the increase of torque ratio is more significant compared with the rolling bearing Type B with a rolling element diameter exceeding 4 mm. In other words, when the grease composition filled in the rolling bearing according to the embodiment is used in a rolling bearing with a rolling element diameter of 4 mm or smaller, more favorable low-speed torque can be obtained, compared with when used in a rolling bearing with a rolling element diameter exceeding 4 mm.

Here, since the value of low-speed torque is usually high in a rolling bearing having a rolling element of large diameter, no major problem has been recognized when conventional grease compositions are used. In contrast, a rolling bearing having a rolling element of small diameter is required to have a low value of low-speed torque, and it has been difficult to achieve the low value of low-speed torque as required when conventional grease compositions are used.

In the configuration in which the aforementioned grease composition is filled in a rolling bearing having a rolling element with a small diameter (for example 5 mm or smaller), more favorable low-speed torque is achieved, compared with a configuration in which the grease composition is filled in a rolling bearing having a rolling element with a large diameter (for example exceeding 5 mm). In the configuration in which the grease composition filled in the rolling bearing according to the embodiment is filled in a rolling bearing with a rolling element diameter of 4 mm or smaller, the effect of achieving favorable low-speed torque is more significant compared with a configuration in which the grease composition is filled in a rolling bearing with a rolling element diameter exceeding 4 mm.

The present invention is susceptible to various modifications based on the technical concept of the present invention. For example, although only one of the additives is added as a dispersant in the foregoing embodiment, they may be combined such that one or more additives among polycarboxylic acid metal salts, fluorine-containing group/lipophilic group-containing oligomers, fluorinated ether diamides and organic acid metal salts may be included.

Although only one of non-fluorine-based thickeners is used in the foregoing embodiment, they may be combined and one or more thickeners among aliphatic-aromatic urea, alicyclic-aliphatic urea and aliphatic urea may be included.

Although a dispersant alone is added as an additive in the foregoing embodiment, other additives including extreme pressure additive, antioxidant, anti-friction agent, metal deactivator, rust preventive, oiliness agent, and viscosity index improver may be added depending on the usage.

The embodiment provides a rolling bearing using a grease composition in which excellent lubricity is kept for long period of use even in a high-temperature environment.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A rolling bearing filled with a grease composition, the grease composition comprising:
a fluorine-based grease including a fluorine-based base oil and a fluorine-based thickener;
a non-fluorine-based grease including a non-fluorine-based base oil and a non-fluorine-based thickener; and
an additive serving as a dispersant, wherein
the non-fluorine-based thickener includes at least one of an aliphatic-aromatic urea, an alicyclic-aliphatic urea and an aliphatic urea, and
the dispersant includes at least one of a polycarboxylic acid metal salt, a fluorine-containing group/lipophilic group-containing oligomer, a fluorinated ether diamide and an organic acid metal salt.

2. The rolling bearing according to claim 1, wherein
the non-fluorine-based thickener includes a diurea compound represented by following general formula (1):
R₁—NHCONH—R₂—NHCONH—R₃ (1)
where R₁ and R₃ are an aliphatic hydrocarbon group, an alicyclic hydrocarbon group or an aromatic hydrocarbon group, wherein at least one of R₁ and R₃ is an aliphatic hydrocarbon group or an alicyclic hydrocarbon group, and R₂ is an aromatic hydrocarbon group.

3. The rolling bearing according to claim 1, wherein
the non-fluorine-based grease is contained in a content rate of 10 wt % to 50 wt % inclusive based on the entire grease composition.

4. The rolling bearing according to claim 2, wherein
the non-fluorine-based grease is contained in a content rate of 10 wt % to 50 wt % inclusive based on the entire grease composition.

5. The rolling bearing according to claim 1, wherein
the non-fluorine-based grease is contained in a content rate of 10 wt % to 30 wt % inclusive based on the entire grease composition.

6. The rolling bearing according to claim 2, wherein
the non-fluorine-based grease is contained in a content rate of 10 wt % to 30 wt % inclusive based on the entire grease composition.

7. The rolling bearing according to claim 3, wherein
the non-fluorine-based grease is contained in a content rate of 10 wt % to 30 wt % inclusive based on the entire grease composition.

8. The rolling bearing according to claim 5, wherein
the rolling bearing has a rolling element having a diameter of 5 mm or less.

9. The rolling bearing according to claim 6, wherein
the rolling bearing has a rolling element having a diameter of 5 mm or less.

10. The rolling bearing according to claim 7, wherein
the rolling bearing has a rolling element having a diameter of 5 mm or less.
